(19) United States
(12) Patent Application Publication
(10) Pub. No.: US 2007/0258015 A1
(43) Pub. Date: Nov. 8, 2007

(54) PASSIVE DIFFUSER FRAME SYSTEM FOR AMBIENT LIGHTING USING A VIDEO DISPLAY UNIT AS LIGHT SOURCE

(75) Inventors: Elmo M.A. Diederiks, Eindhoven (NL); Mark J. Elting, Ossining, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/571,287

(22) PCT Filed: Jun. 27, 2005
(86) PCT No.: PCT/IB05/52123

§ 371 Date: Dec. 26, 2006

Related U.S. Application Data
(60) Provisional application No. 60/584,199, filed on Jun. 30, 2004.
(60) Provisional application No. 60/625,671, filed on Nov. 5, 2004.

(51) Int. Cl. H04N 5/72

(52) U.S. Cl. 348/739; 348/781; 348/E05.136

(57) ABSTRACT

Passive diffuser frame uses light emitted from a video display front face to produce cold emission ambient lighting effects, having a light guide capturing display image light and in optical communication with a distributive outer frame that redirects that light. The ambient light can be diffuse, non-image forming, directed as spill light or to a light pipe. A goniophotometric element or goniochromatic element allows changing intensity or color of ambient light as a function of viewing angles. The light guide can use a prism splitter or partial reflector, to redirect light and allow viewing the original display image simultaneously. Additive and subtractive color mixing and photoluminescent substances allow new chromaticities, including fluorescent colors and new colors outside of the gamut of output light colors inherently producible by the unaided video display unit.

This invention relates to video displays and the production of ambient lighting effects therefrom. More particularly, it relates to a passive diffuser frame system for using video display light as a light source for ambient distribution, including spatial and colorimetric transformation of the display light to produce effects not capable of being provided by a conventional video display unit or light-transmissive device.

Engineers have long sought to broaden the sensory experience obtained consuming video content, such as by enlarging viewing screens and projection areas, modulating sound for realistic 3-dimensional effects, and enhancing video images, including broader video color gamuts, resolution, and picture aspect ratios, such as with high definition (HD) digital TV television and video systems. Moreover, film, TV, and video producers also try to influence the experience of the viewer using visual and auditory means, such as by clever use of color, scene cuts, viewing angles, peripheral scenery, and computer-assisted graphical representations. This would include theatrical stage lighting as well. Lighting effects, for example, are usually scripted—synchronized with video or play scenes—and reproduced with the aid of a machine or computer programmed with the appropriate scene scripts encoded with the desired schemes. Automatic adaptation of lighting to fast changes in a scene, particularly unplanned or unscripted scenes, is not usually possible.

Philips (Netherlands) and other companies have disclosed means for changing ambient or peripheral lighting to enhance video content for typical home or business applications, but this involves using traditional light sources, and some sort of advance scripting or encoding of the desired lighting effects. This scripting and the use of traditional light sources is not always possible or desired.

This invention uses captured video display light from a video display unit itself to produce light atmospheres and effects, using a passive frame light guide and emitter. The video display unit can use any technology or platform, such as CRT (Cathode Ray Tube); LCD (Liquid Crystal Display); PDP (Plasma Display Panel); FED (Field Emission Display) or other technologies. It is even applicable to any transmissive medium for the delivery of video or visual information, such as found in a window of a building. For clarity of discussion, video displays shall be used here for illustrative purposes.

Sensory experiences are naturally a function of aspects of human vision, which uses an enormously complex sensory and neural apparatus to produce sensations of color and light effects. Humans can distinguish perhaps 10 million distinct colors. In the human eye, for color-receiving or photopic vision, there are three sets of approximately 2 million sensory bodies called cones which have absorption distributions which peak at 445, 535, and 565 nm light wavelengths, with a great deal of overlap. These three cone types form what is called a tristimulus system and are called B (blue), G (green), and R (red) for historical reasons; the peaks do not necessarily correspond with those of any primary colors used in a display, e.g., commonly used RGB phosphors. There is also interaction for scotopic, or so-called night vision bodies called rods. The human eye typically has 120 million rods, which influence video experiences, especially for low light conditions such as found in a home theatre.

Color video is founded upon the principles of human vision, and well known trichromatic and opponent channel theories of human vision have been incorporated into our understanding of how to influence the eye to see desired colors and effects which have high fidelity to an original or intended image. In most color models and spaces, three dimensions or coordinates are used to describe human visual experience.

Color video relies absolutely on metamerism, which allows production of color perception using a small number of reference stimuli, rather than actual light of the desired color and character. In this way, a whole gamut of colors is reproduced in the human mind using a limited number of reference stimuli, such as well known RGB (red, green, blue) tristimulus systems used in video reproduction worldwide. It is well known, for example, that nearly all video displays show yellow scene light by producing approximately equal amounts of red and green light in each pixel or picture element. The pixels are small in relation to the solid angle they subtend, and the eye is fooled into perceiving yellow; it does not perceive the green or red that is actually being broadcast.

There exist many color models and ways of specifying colors, including well known CIE (Commission Internationale de l'Eclairage) color coordinate systems in use to describe and specify color for video reproduction. Nothing in this disclosure precludes use of displays or color spaces using distimuli or quadrastimuli systems, or systems producing many reference stimuli. Any number of color models can be employed using the instant invention, including application to opponent color spaces, such as the CIE L*U*V* (CIELUV) or CIE L*a*b* (CIELAB) systems. The CIE established in 1931 a foundation for all color management and reproduction, and the result is a chromaticity diagram which uses three coordinates, x, y, and z. A plot of this three dimensional system at maximum luminosity is universally used to describe color in terms of x and y, and this plot, called the 1931 x,y chromaticity diagram, is believed to be able to describe all perceived color in humans. This is in contrast to color reproduction, where metamerism is used to fool the eye and brain. Many color models or spaces are in use today for reproducing color by using three primary colors or phosphors, among them ISO RGB, Adobe RGB, NTSC RGB, etc.

It is important to note, however, that the range of all possible colors exhibited by video systems using these tristimulus systems is limited. The NTSC (National Television Standards Committee) RGB system has a relatively wide range of colors available, but this system can only reproduce half of all colors perceivable by humans. Many blues and violets, blue-greens, and oranges/reds are not rendered adequately using the available scope of traditional video systems.

Furthermore, the human visual system is endowed with qualities of compensation and discernment whose understanding is necessary to design any video system. Color in humans can occur in several modes of appearance, among them, object mode and illuminant mode.

In object mode, the light stimulus is perceived as light reflected from an object illuminated by a light source. In illuminant mode, the light stimulus is seen as a source of light. Illuminant mode includes stimuli in a complex field that are much brighter than other stimuli. It does not include stimuli known to be light sources, such as video displays, whose brightness or luminance is at or below the overall brightness of the scene or field of view so that the stimuli appear to be in object mode.

Remarkably, there are many colors which appear only in object mode, among them, brown, olive, maroon, grey, and beige flesh tone. There is no such thing, for example, as a brown illuminant source of light, such as a brown-colored traffic light.

For this reason, supplements to video systems which attempt to add object colors cannot do so using direct sources of light. No combination of bright red and green LEDs (light emitting diodes) at close range can reproduce brown or maroon, and this limits choices considerably. Only spectral colors of the rainbow, in varying intensities and saturation, can be reproduced by direct observation of bright sources of light.

It is therefore advantageous to exceed the available gamut of colors available to traditional light sources. It is also advantageous to expand the possible gamut of colors reproduced by a typical tristimulus video system. Finally, it is also desired to exploit characteristics of the human eye, such as changes in relative luminosity of different colors as a function of light levels, by modulating or changing color delivered to the video user.

Information about human vision, color science and perception, color spaces, colorimetry and image rendering, including video reproduction, can be found in the following references which are hereby incorporated into this disclosure in their entirety: ref[1] Color Perception, Alan R. Robertson, Physics Today, December 1992, Vol 45, No 12, pp. 24-29; ref[2] The Physics and Chemistry of Color, 2ed, Kurt Nassau, John Wiley & Sons, Inc., New York C) 2001; ref[3] Principles of Color Technology, 3ed, Roy S. Berns, John Wiley & Sons, Inc., New York, (C 2000; ref[4] Standard Handbook of Video and Television Engineering, 4ed, Jerry Whitaker and K. Blair Benson, McGraw-Hill, New York © 2003.

Prior art frames that surround video screens do not function in the way the present invention does to capture, redirect, and broadcast light as taught here. In contrast to many prior art designs, this invention does not get involved with side light inside a display, such as a traditional CRT. This invention captures light from the front display face only, in contrast, for example, to U.S. Pat. No. 2,837,734 to R. M. Bowie, Surround-Lighting Structure, where CRT side light from a band of transparent glass 22 is captured by a planar transparent member 30.

The invention relates to a apparatus and method for a passive diffuser frame system for a video display unit that uses two functional components which can be optionally borne by a single physical component: a light guide sized, formed and positioned to allow optical communication with the video display unit so as to capture some of its output light; and a distributive outer frame in optical communication with the light guide, with the distributive outer frame so sized, positioned and optically formed as to redirect the output light from itself to become cold emission ambient light.

The distributive outer frame can be formed optically to provide an optical diffuser to provide non-imaging ambient light, or formed optically to enable light to be spilled or back-spilled in at least one spill direction that is contrary to that of the output light outwardly emitted by the video display. The distributive outer frame can also be optically formed to provide non-isotropic redirection of the output light to selected portions of itself, such as a goniophotometric element, which allows that the cold emission ambient light changes intensity as a function of viewing angle. Light pipes can be fitted to or integral with the distributive outer frame to further direct ambient light into the space around the display.

The light guide can be so formed to split, by reflection, some of the output light from the video display unit to be redirected, whereas other output light is allowed to pass substantially outwardly therefrom as imaging light discernible by a viewer. This allows use of the passive diffuser frame without losing part of the original image from the display.

For example, a splitter prism can be used which comprises a critical surface sized, positioned and formed to internally reflect and redirect substantially some of the output light, and to be substantially transparent to other output light, thereby allowing the image light to emerge from the critical surface. This particular arrangement allows at least discernment of an original image inherently emitted by the video display unit immediately adjacent the light guide with which it is in optical communication.

Alternatively, the light guide can comprises a partially reflective splitter which comprises a partially reflective surface that performs the same function.

When in use, the passive diffuser frame is formed to allow that two chromatically distinct illuminant sources in the output light at different positions in the video display unit display area can be mixed together to form a mixed image in viewer object or illuminant mode of a different chromaticity than original chromaticities of either of the two chromatically distinct illuminant sources. In object mode, this allows that the mixed image can resemble an object mode color such as brown, olive, maroon, grey, and beige flesh tone, colors which are impossible to create with normal bright light sources (e.g., LEDs) at close range.

To further color modulate the ambient light generated, the distributive outer frame can comprise at least one absorber, reflective, or transmissive, (e.g., a dye or thin metal foil) to remove a portion of a spectral distribution of the output light so as to change the color of the ambient light.

More exciting color modulation for home theatre can be effected using another embodiment of the invention wherein the distributive outer frame comprises at least one photo-luminescent emitter to provide a spectral modification of the output light so as to color-modify the ambient light emitted from at least a portion of the passive diffuser frame system.

The photoluminescent emitter can comprise a fluorescent material, and that photoluminescent material can be chosen to

[1] exceed a MacAdam limit when the ambient light is perceived by a viewer; and/or

[2] produce a new color that is outside of a gamut of the output light colors inherently producible by the video display unit unaided by the passive diffuser frame.

The photo-luminescent emitter can also produce time-delayed effects by employing a phosphorescent material with a luminous relaxation time constant of greater than 10ˆ-8 seconds, such as one second.

In addition to providing an embodiment that uses a goniophotometric element so as to provide ambient light which changes intensity as a function of an angle of observation of the passive diffuser frame system, this disclosure also teaches use of embodiments which are goniochromatic, so as to provide ambient light which changes color as a function of an angle of observation. Such goniochromatic elements include optical prisms and lenses, and reflective and transmissive surfaces which can fabricated by scoring or otherwise modifying the surface characteristics of the goniochromatic element, and/or by employing goniochromatic material, such as metal flakes, glass flakes, plastic flakes, particulate matter, oil, fish scale essence, thin flakes of guanine, 2-aminohypoxanthine, ground mica, ground glass, ground plastic, pearlescent material, bornite, and peacock ore.

Methods given include a method for providing cold emission ambient light from output light emitted by a video display and captured by a passive diffuser frame, comprising:

[1] Capturing the output light from the display using a light guide;

[2] Redirecting at least a portion of the output light to a surface in a distributive outer frame formed and positioned for perception by a viewer. Optional added steps include:

[3] Conditioning the output light using an appropriately formed distributive outer frame such that the output light becomes non-imaging light;

[4] Conditioning the output light using a diffuser such that the output light becomes non-imaging light;

[5] Redirecting the output light using a distributive outer frame so formed, sized and positioned to spill the ambient light;

[6] Redirecting the output light non-isotropically;

[7] Redirecting the output light using a light pipe to redirect the output light to become ambient light by transmission therethrough;

[8] Redirecting the output light using a distributive outer frame so formed, sized and positioned to split, by reflection, some of the output light from the video display unit to be redirected, and to allow other output light to pass substantially outwardly therefrom as imaging light;

[9] Mixing together two chromatically distinct illuminant sources in the output light at different positions in the video display unit display area to form a mixed image in viewer object mode of a different chromaticity than original chromaticities of either of the two chromatically distinct illuminant sources;

[10] Producing the different chromaticity in an object mode color selected from the group consisting of: brown, olive, maroon, grey, and beige flesh tone;

[11] Mixing together two chromatically distinct illuminant sources in the output light at different positions in the video display unit display area to form a mixed image in viewer illuminant mode of a different chromaticity than original chromaticities of either of the two chromatically distinct illuminant sources;

[12] Using an absorber in the distributive outer frame to remove a portion of a spectral distribution of the output light so as to change the color of the ambient light;

[13] Interacting the output light with a photo-luminescent emitter to provide a spectral modification of the output light so as to color-modify the ambient light emitted from at least a portion of the passive diffuser frame;

[14] Interacting the output light with a phosphorescent material to provide a spectral modification of the output light so as to color-modify the ambient light emitted from at least a portion of the passive diffuser frame, the phosphorescent material having long relaxation time of greater than 10ˆ-8 seconds;

[15] Producing at least one new color in the ambient light produced during light output from the display, the new color outside of a gamut of the output light colors inherently producible by the video display unit unaided by the passive diffuser frame;

[16] Providing ambient light which is goniophotometric, that is, changing intensity as a function of an angle of observation of the passive diffuser frame system, using a goniophotometric element in optical communication with the output light in the distributive outer frame;

[17] Reflecting the output light off of the goniophotometric element;

[18] Transmitting the output light through the goniophotometric element;

[19] Providing ambient light which is goniochromatic, that is, changing color as a function of an angle of observation of the passive diffuser frame system, using a goniochromatic element in optical communication with the output light in the distributive outer frame;

[20] Reflecting the output light off of the goniochromatic element; and

[21] Transmitting the output light through the goniochromatic element.

FIG. 1 shows a frontal surface view of a rectangular video display, with a fiduciary area dedicated for production of ambient light;

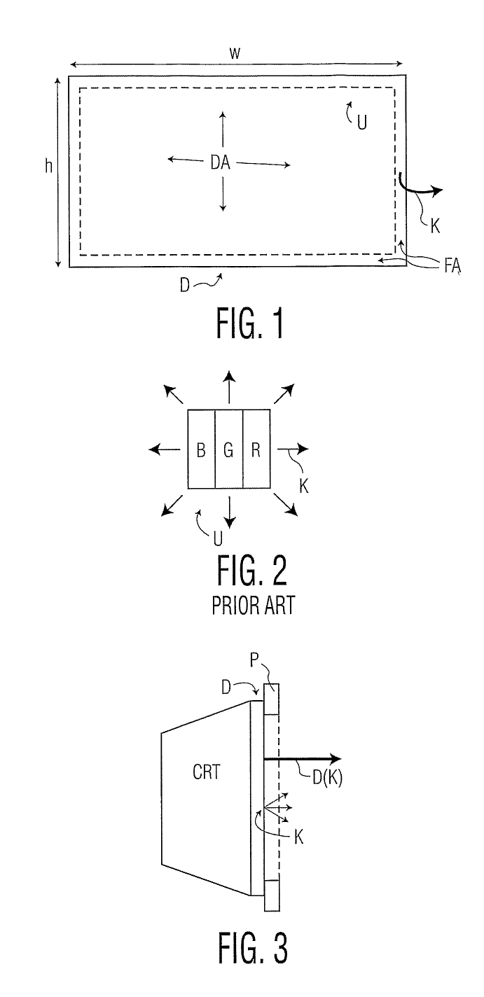

FIG. 2 shows a frontal schematic view of a conventional RGB video pixel in the display of FIG. 1;

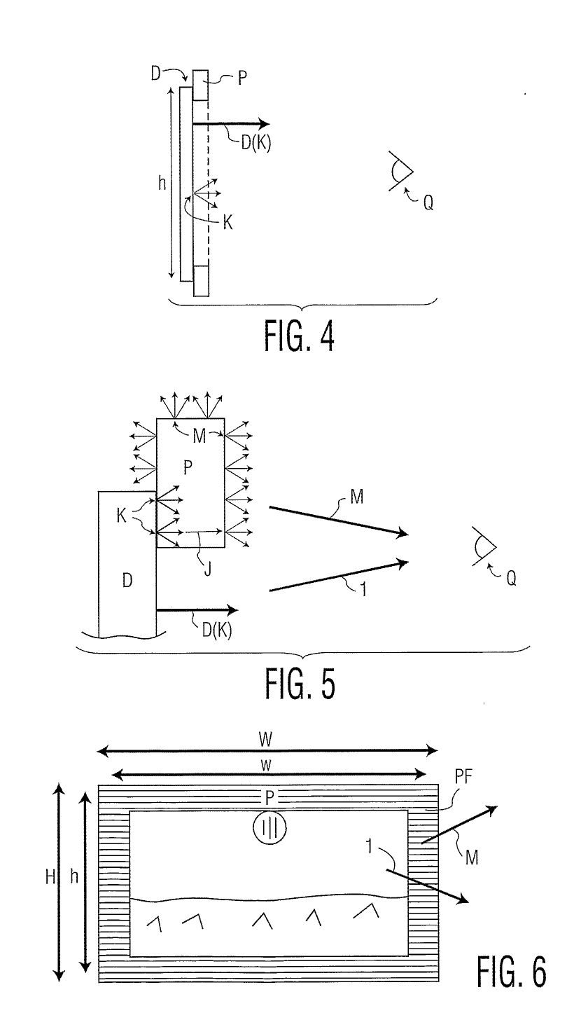

FIGS. 3 and 4 show a schematic cross-sectional side view of a cathode-ray tube display and a flat panel display, respectively, fitted with one passive diffuser frame according to the invention;

FIG. 5 shows a close-up view of the upper portion of the schematic cross-section of FIG. 4, showing generalized light flows;

FIG. 6 shows a frontal schematic view of a display using a passive frame to broadcast display scene light into an ambient environment;

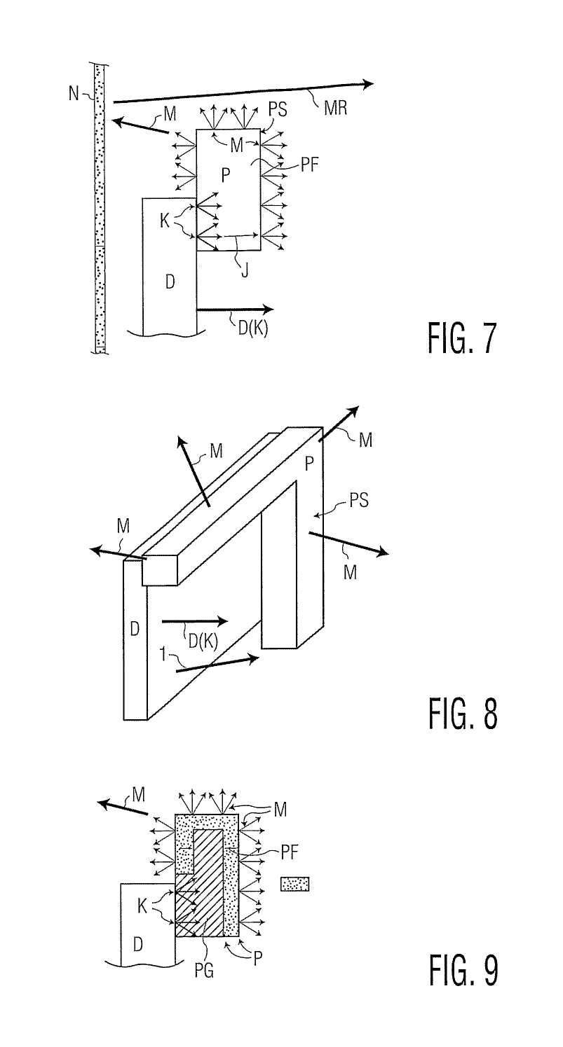

FIG. 7 shows the schematic view of FIG. 5 with ambient light spilling onto a back wall;

FIG. 8 shows an oblique schematic view of the upper right portion of a display, fitted with a generalized block passive frame according to the invention;

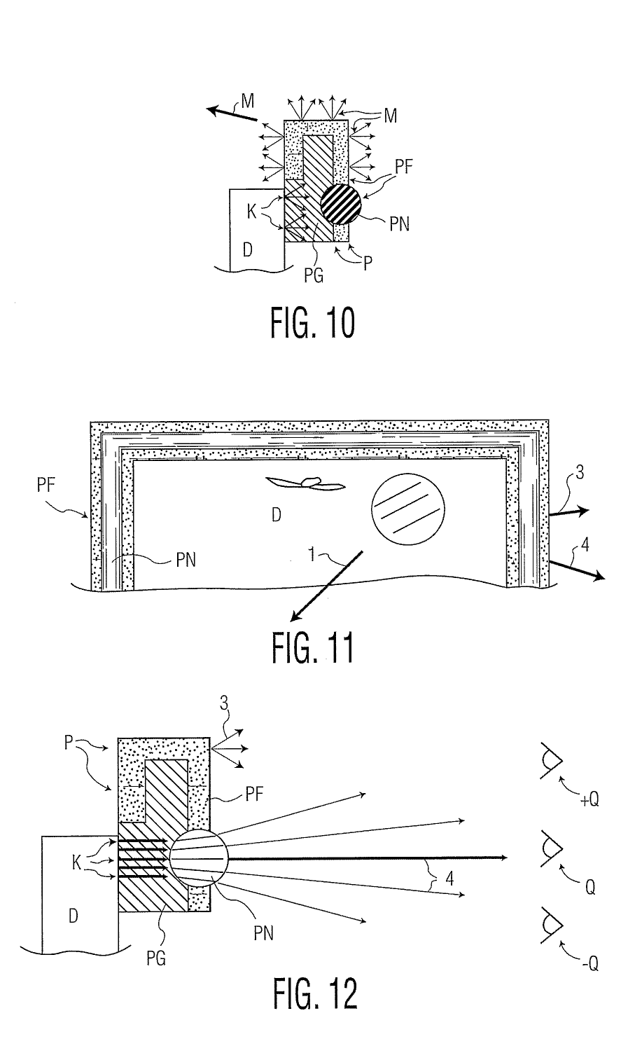

FIG. 9 shows a close-up cross-sectional schematic view similar to that of FIGS. 5 and 7, where the passive diffuser frame comprises a light guide and a distributive outer frame with diffuser;

FIG. 10 shows the passive diffuser frame of FIG. 9, fitted with one type of goniophotometric element;

FIG. 11 shows a frontal schematic view similar to that of FIG. 6 for the goniophotometric passive diffuser frame of FIG. 10;

FIG. 12 shows the passive diffuser frame of FIG. 10, demonstrating the goniophotometric effect which gives different light intensity and character as a function of viewing angle;

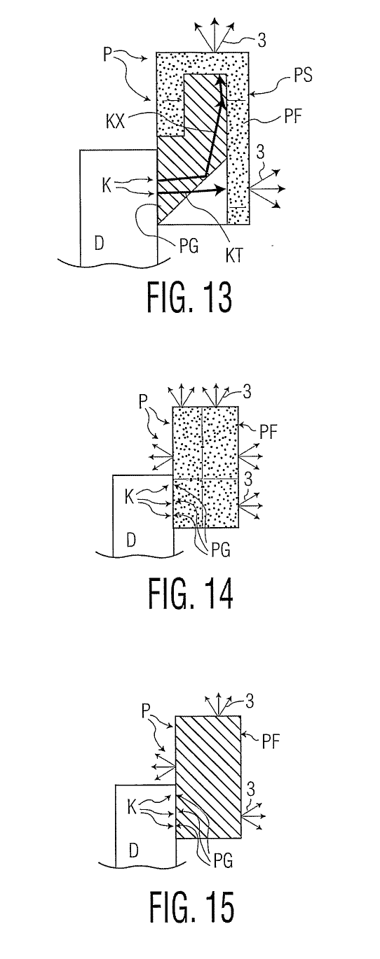

FIG. 13 shows a passive diffuser frame similar to that of FIG. 9, using partial internal reflection inside a transparent light guide to aid in distribution of light into a diffuser for ambient distribution;

FIG. 14 shows a view similar to that of FIG. 13, using a simple block diffuser as a light guide and a distributive outer frame;

FIG. 15 shows a view similar to that of FIG. 14, using a simple transmissive block as a light guide and a distributive outer frame;

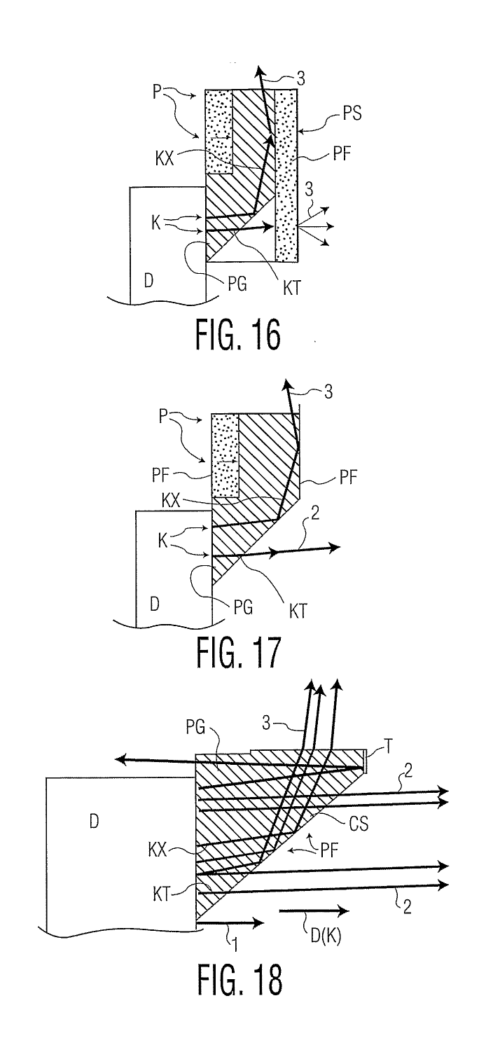

FIG. 16 shows the passive diffuser frame of FIG. 13, where the transparent light guide is formed to allow pumping of ambient light upward, without a frontal diffuser;

FIGS. 17 and 18 show close-up cross-sectional views of the upper portion of a display fitted with a splitter-prism equipped passive diffuser frame according to another embodiment of the invention, comprising a light guide and distributive outer frame using partial internal reflection at a critical surface to redirect light for ambient distribution, also providing simultaneous forward transmission of light for enabling viewing of display image light, with schematic light rays shown, including frame image light, and non-imaging ambient light;

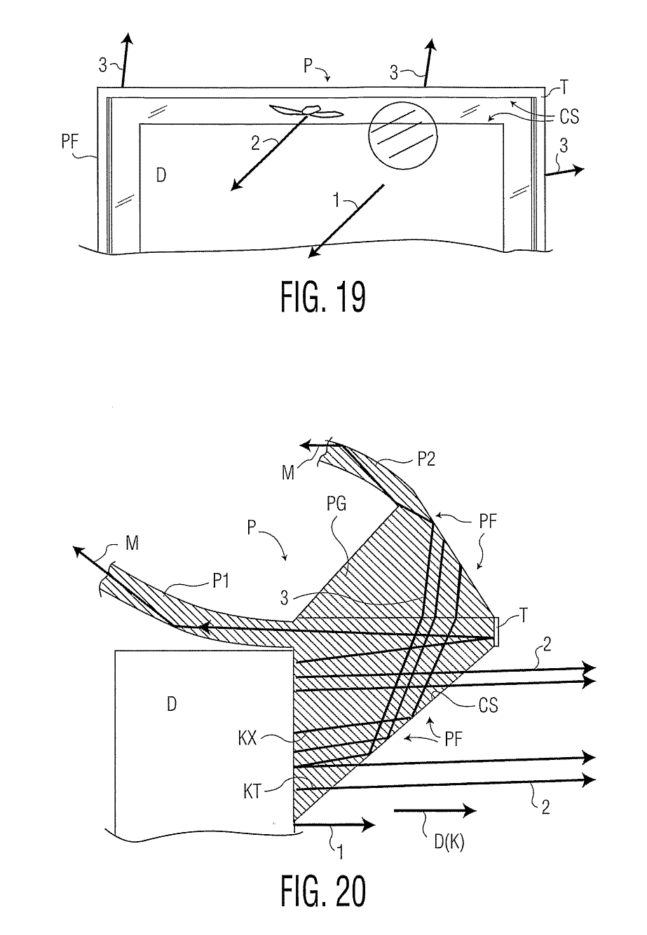

FIG. 19 shows the frontal schematic view the upper portion of a display and passive frame of the embodiment of FIG. 18, showing continuity of an image through the passive diffuser frame and production of ambient light;

FIG. 20 shows the embodiment of FIG. 18, where the light guide comprises two light pipes for further distribution of ambient light;

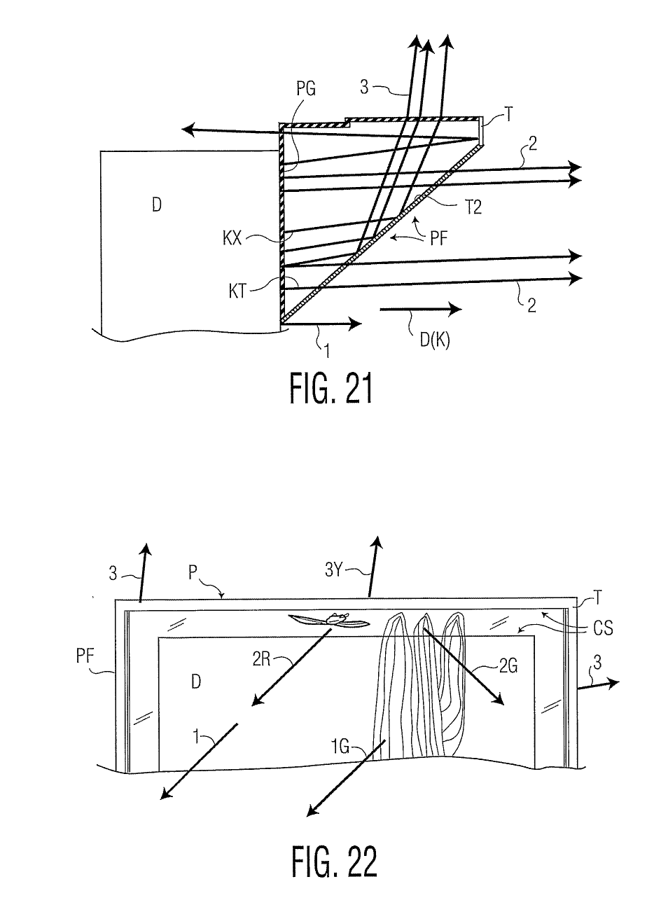

FIG. 21 shows an another embodiment of the invention similar in function to that shown in FIG. 18, using a partial reflector in lieu of internal reflection at a critical surface, and using a frontal reflector to enhance back spill of ambient light;

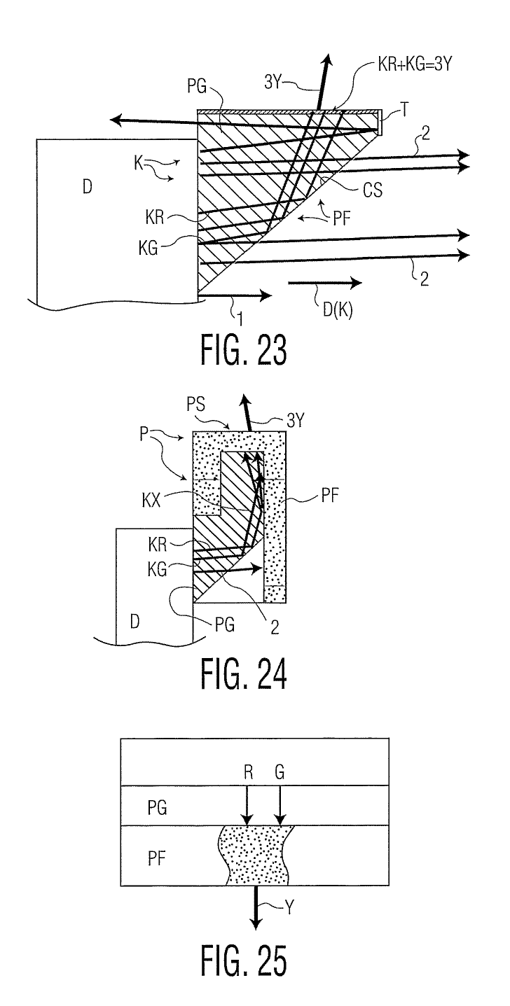

FIGS. 22 and 23 show the embodiment of FIGS. 18 and 19, using similar views already shown, and demonstrating color mixing of a color composite image on a video display to produce a ambient light chromaticity that is the result of combining the output of many display pixels in disparate display areas, with red and green original video image color elements in a scene combining to produce yellow ambient light;

FIGS. 24 and 25 show the embodiment of FIG. 13 to demonstrate the additive color mixing of FIG. 23, using high intensity red and green original display image light to produce yellow ambient light in illuminant mode, where FIG. 25 shows the process in a basic block schematic diagram;

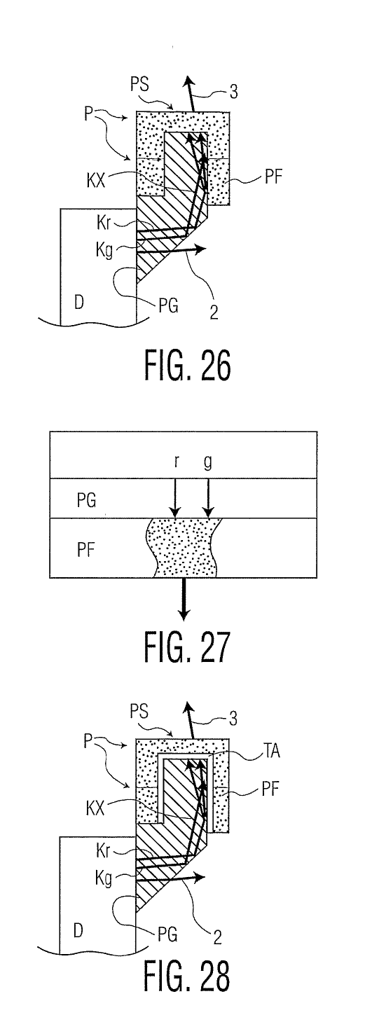

FIGS. 26 and 27 show the embodiment of FIG. 13 to demonstrate the additive color mixing of FIG. 23, using low intensity red and green original display image light to produce brown ambient light in object mode, where FIG. 27 shows the process in a basic block schematic diagram;

FIGS. 28-31 show similar paired drawings similar to those of FIGS. 24-27, for two more illustrative embodiments of the invention where the passive diffuser frame comprises a transmissive absorber, and a reflective absorber, respectively, with light subtraction and addition processes shown;

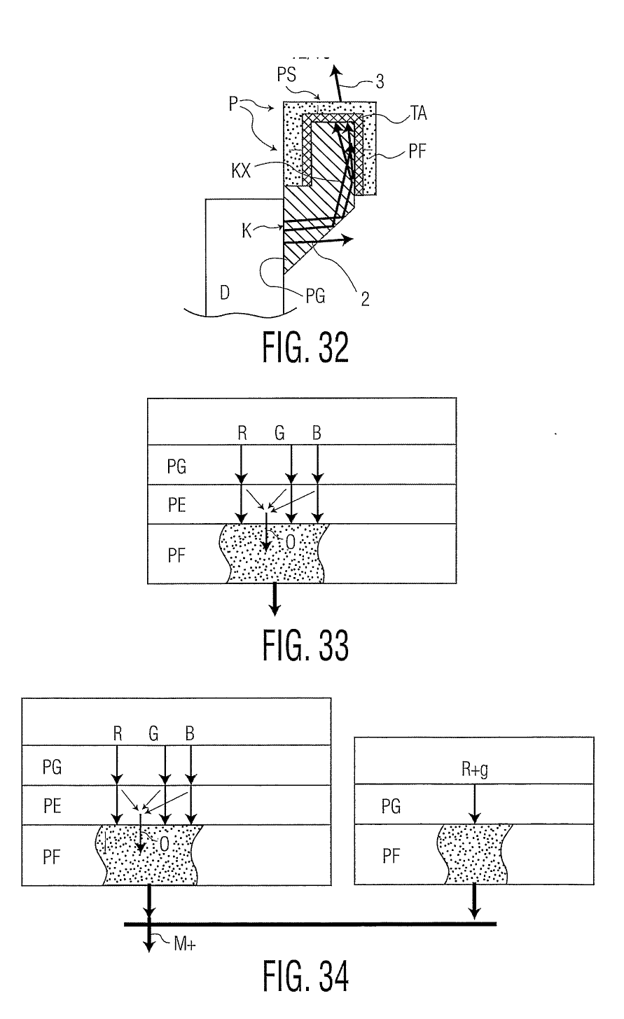

FIGS. 32 and 33 show another embodiment of the invention whereby the passive diffuser frame performs a color transformation using a photoluminescent emitter interposed between the light guide and the distributive outer frame to produce ambient light having new colors not originally present in the original video image, using excitation and re-emission by a fluorescent pigment, having the process schematically shown in FIG. 33;

FIG. 34 shows a comparison between the color transformation process of FIG. 33 according to the invention with that of conventional video color production by the display, showing schematically an original video image using primaries R, G and B to produce a new orange color not inherently producible by the display, and compared to production of the nearest color chromaticity using light inherently produced by the display. The figure shows that the light produced by a passive diffuser frame using a photoluminescent emitter according to the invention can exceed the MacAdam limit for that chromaticity;

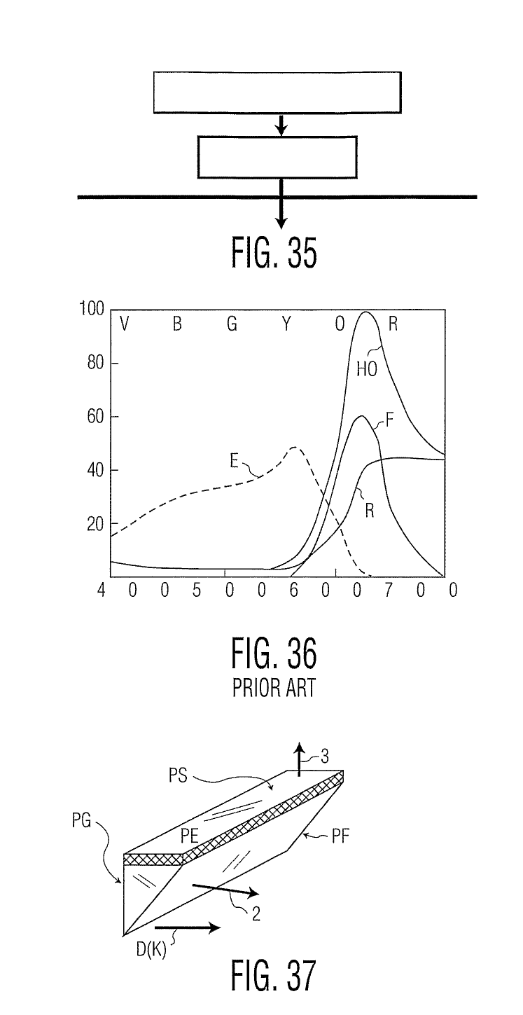

FIG. 35 shows generally in block schematic the process by which fluorescence can be used by the passive diffuser frame of the invention to produce a color outside the gamut of colors ordinarily produced by the video display;

FIG. 36 shows a prior art plot of activation, reflection, fluorescence, and total output spectral distributions for a typical fluorescent material that might be used for the embodiment illustrated by FIGS. 32-35;

FIG. 37 shows a cross-sectional oblique view of a simple splitter prism passive diffuser frame element comprising a photoluminescent emitter for conditioning output light into ambient light;

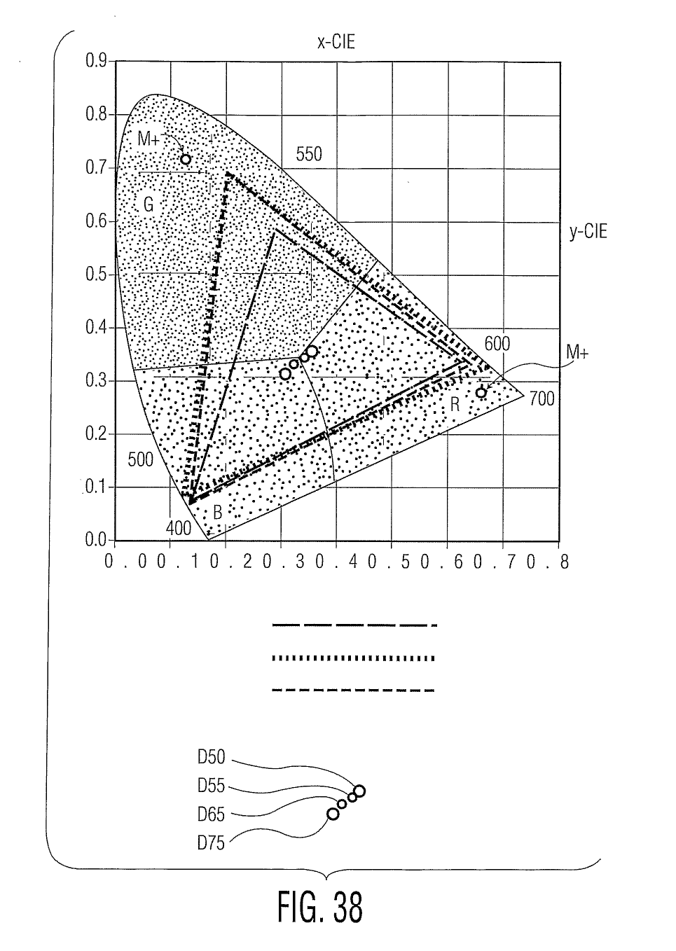

FIG. 38 shows two possible colors or chromaticity coordinates on a standard CIE color map which lie outside the gamut of colors obtainable by PAL/SECAM, NTSC, and Adobe RGB color production methods;

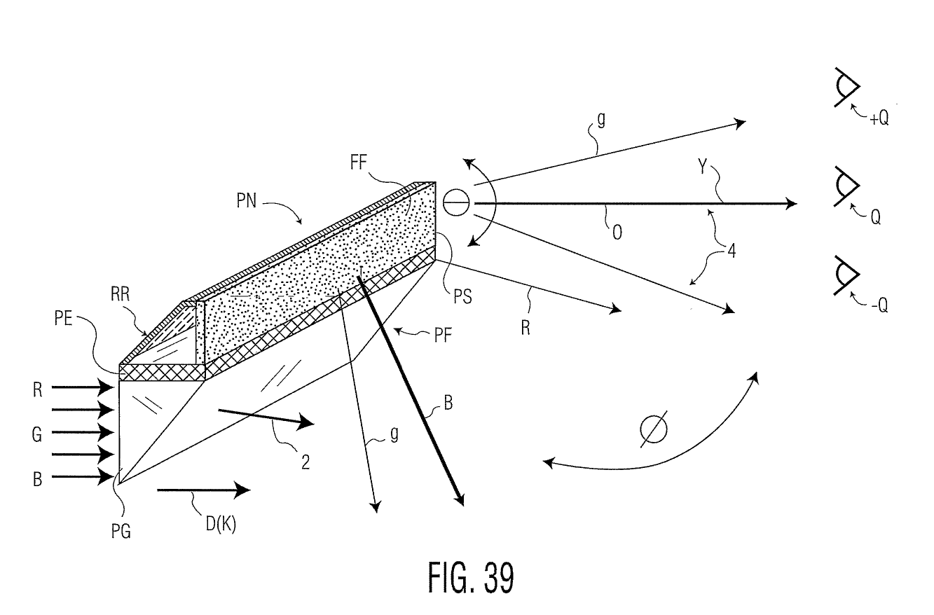

FIG. 39 shows another embodiment of the invention where the passive diffuser frame comprises a goniochromatic element to produce different light colors, intensity, and character as a function of viewing angles Theta and Phi. The passive diffuser frame is shown as an oblique cross-section comprising a light guide and/or distributive outer frame in optical communication with a goniochromatic element, and with a photoluminescent emitter interposed therebetween;

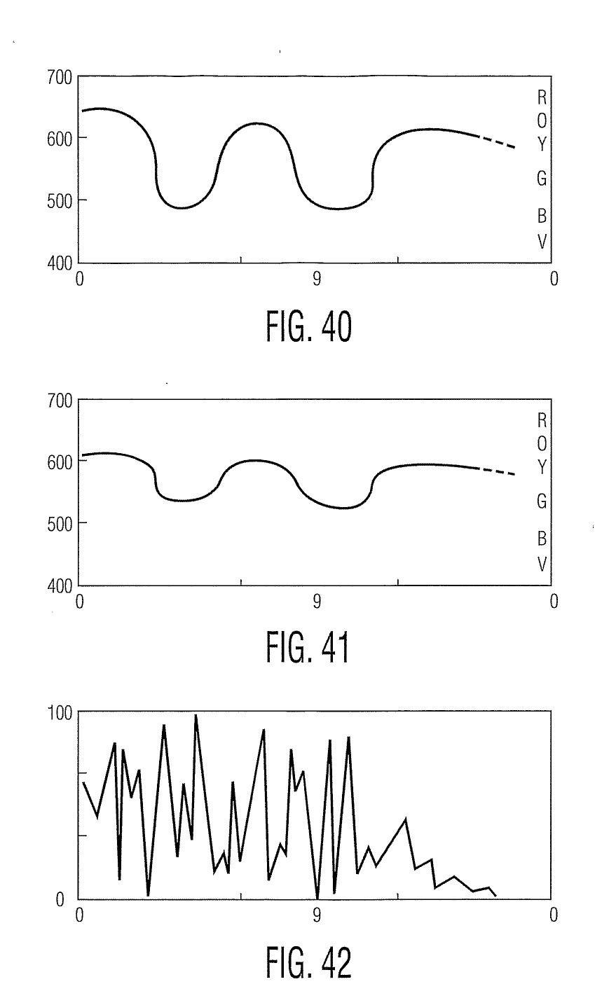

FIGS. 40 and 41 show Cartesian plots of dominant color wavelength of ambient light produced versus viewing angles Phi and Theta, respectively, for the goniochromatic embodiment illustrated in FIG. 39;

FIG. 42 shows a Cartesian plot of relative light intensity of ambient light produced versus viewing angle Phi, for the goniochromatic embodiment illustrated in FIG. 39.

The following definitions shall be used throughout:
Ambient Light—shall connote light that is surrounding, encircling, or being emitted about or near a display, such as emanating from a distributive outer frame or spilled onto a wall or generally outward behind the display. This is in contrast to light which is outwardly emitted by a display by its inherent design.
Diffuse—shall denote that quality of light interaction which is non-image transmitting and typically somewhat or substantially isotropic in intensity or luminance. The title of this invention, however, uses the more general lay meaning, connoting distribution, and not necessarily image-removing.
Distributive outer frame—shall refer to that portion of a passive diffuser frame which rebroadcasts light obtained from a light guide. A distributive outer frame can be remote, such as an optical body in optical communication with light pipes as shown in FIG. 20.
Goniophotometric—shall refer to the quality of giving different light intensity, transmission and/or color as a function of viewing angle or angle of observation, such as found in pearlescent, sparkling or retroreflective phenomena.
Goniochromatic—shall refer to the quality of giving different color or chromaticity as a function of viewing angle or angle of observation, such as produced by iridescence.
Imaging light—or image light is light which allows a standard observer or any other observer to discern the appearance or likeness portrayed by a display, such as light which passes through a splitter prism according to one embodiment of the invention, allowing the original likeness of the video display image to be transmitted to a viewer.
Light guide—shall denote any structure or that portion of a passive diffuser frame that receives light from a video display unit according to the invention. A light guide can be in mechanical contact with the display unit, such as a Lucite® prism mounted in front of same, or it can be suspended or remote, and merely interposed to be in optical communication with the display. A passive diffuser frame taking the form of a prism block can integrate both the functions of the light guide and the distributive outer frame. They do not have to be separate components.

Transparent—shall include somewhat transparent, as well as nearly 100% transparent.

Video—shall denote any visual or light producing device, whether an active device requiring energy for light production, or any transmissive medium which conveys image information, such as a window in an office building, or an optical guide where image information is derived remotely.

Referring now to FIG. 1, a frontal surface view of a rectangular video display D is shown, having a total active or light producing frontal surface area DA equal to the product of height h and width w, as shown. Display D comprises a number picture elements or pixels U which produce display output light K, as shown. A peripheral area, shown as FA, serves for illustrative purposes as a fiducial area dedicated for production and distribution of ambient light using the instant invention.

Referring now to FIG. 2, a frontal schematic view of a conventional RGB video pixel in the display of FIG. 1 is shown. As with most displays, display output light K from subpixels or constituents portions of pixel U is multi-directional, so that the video display D can be viewed conveniently from a wide range of angles. This multi-directionality of output will be used to advantage, such as found in the embodiment described in FIG. 18.

Now referring to FIGS. 3 and 4, schematic cross-sectional side views are shown of a cathode-ray tube display and a flat panel display, respectively. In each figure, display D is oriented so that its display output light K is emitted in multiple directions to the right on the page as shown, in a general output light outward direction D(K) as shown. Each display D is fitted with one passive diffuser frame P according to the invention so that it is in optical communication with the display, capturing light from the fiducial area FA as shown in FIG. 1. For clarity, only the active portion of displays are shown here, so that the full display height h as shown is active. At some distance away in the general direction D(K) is an observer or viewer Q, shown schematically as an eye section.

Now referring to FIG. 5, a close-up view of the upper portion of the schematic cross-section of FIG. 4 is shown. The upper portion of the side of display D is shown optically coupled to passive diffuser frame P. Passive diffuser frame P can be mounted mechanically onto display D, and can include flanges and slip-on geometry for that purpose, or it can be suspended to be merely in optical communication with display D. Passive diffuser frame P can be made of a number of commonly available transparent or translucent materials such as clear plastics like Lexan®, Lucite®, and many other polymer resins, such as PET and ABS resin, and formed using known fabrication techniques. Any known stable light transmissive material can be used that has requisite mechanical and optical properties. The portion of passive diffuser frame P which allows display output light K to enter and optically couple into the passive diffuser frame P shall be called a light guide; the portion that serves to rebroadcast that light to become ambient light shall be called a distributive outer frame, as will be noted below. Display output light K is then redirected, shown as redirected light J, to become ambient light M as shown. Ambient light M can be emitted in any direction, such as toward a viewer Q as shown, and also in directions contrary to general output light outward direction D(K), such as spilled light (shown, Spill) away from viewer Q. Viewer Q thus receives original display image light 1 as shown from non-fiducial areas of the display, as well as ambient light M emanating from passive diffuser frame P as shown.

Now referring to FIG. 6, the general effect is shown illustratively. A frontal schematic view is shown of a display D using a passive diffuser frame P to capture display scene light (a sun and rudimentary ground features are shown) from the fiducial area FA as shown in in FIG. 1. This light is captured using a light guide (not shown) for redistribution by a distributive outer frame PF (shown) into the ambient environment as ambient light M. There are no limits on the geometry of distributive outer frame PF, shown here having a height H and width W larger than height h and width w of the active display D as shown in FIG. 1.

FIG. 7 shows the schematic view of FIG. 5 with ambient light spilling onto a back wall N, becoming ambient reflected light NM, which presumably can be seen by a viewer along with original display image light sent in the general output light outward direction D(K). Distributive outer frame PF comprises a distributive outer frame surface PS, which is the actual emitting surface for ambient light M. Passive diffuser frame P can embody various diffuser effects to produce translucence or other phenomena, such as a frosted or glazed surface PS; ribbed glass or plastic; or apertured structures, such as by using metal or other internal blockers, depending on the visual effect desired. A simple passive diffuser frame P is shown here for clarity.

As shown in FIG. 8, it is expected, but not required, that a passive diffuser frame P according to the invention will be peripheral in nature, using only light from a fiducial area FA on the display periphery. FIG. 8 shows an oblique schematic view of the upper right portion of a display D, fitted with a generalized block passive frame P according to the invention. Only a portion of the frame is shown for clarity. Notice how ambient light M can be emitted in directions contrary to general output light outward direction D(K), including the sides and top of the display D.

Now referring to FIG. 9, a close-up cross-sectional schematic view similar to that of FIGS. 5 and 7 is shown, where the passive diffuser frame comprises a light guide PG for coupling optically into the display D, and distributive outer frame PF for emitting display output light K thus obtained and redirected to become ambient light M. Display output light K enters light guide PG and is broadcast internally to distributive outer frame PF as shown.

Distributive outer frame PF can, as illustrated here schematically, comprise a diffuser to change the character of the ambient light, making it non-image light. Any number of known diffusing or scattering materials or phenomena can be used, including scattering from small suspended particles inside the diffuser body; rigid foam; clouded plastics or resins, preparations using colloids, emulsions, or globules 1-5:m or less, such as less than 1:m, including long-life organic mixtures; gels; and sols, the production and fabrication of which is known by those skilled in the art. Scattering phenomena can be engineered to include Rayleigh scattering for visible wavelengths, such as for blue production for blue enhancement of ambient light. The colors produced can be defined regionally, such as an overall bluish tint in certain areas or regional tints, such as a blue light-producing top section.

Now referring to FIGS. 10-12, another embodiment of the invention is shown whereby the passive diffuser frame P is functionally goniophotometric. FIG. 10 shows this embodiment of the invention, where the passive diffuser frame of FIG. 9 is fitted with one type of goniophotometric element PN, shown here as a cylindrical prism or lens formed within, integral to, or inserted within light guide PG and/or distributive outer frame PF. This allows special effects where the character of the ambient light M produced changes as a function of the position of the viewer. The appearance of the passive diffuser frame P and display D is shown in FIG. 11, where a frontal schematic view similar to that of FIG. 6 is shown for the goniophotometric passive diffuser frame of FIG. 10. Display D emits original display image light 1 as shown. With distributive outer frame PF having a diffuser core or feature, ambient light M takes the form of frame non-image light 3 as shown, and also frame non-image goniophotometric light 4 which emanates from the goniophotometric element PN shown in cross-section in FIG. 10. The effect of this optical form can be seen in FIG. 12, which again shows the passive diffuser frame of FIG. 10, and demonstrates the goniophotometric effect which gives different light intensity and character for frame non-image goniophotometric light 4 as a function of viewing angle. Display output light K enters the cylindrical prism or goniophotometric element PN through light guide PG, as shown. In the sample rays shown, light is non-isotropically redirected out of the goniophotometric element PN—depending on the entry point on the cylindrical surface of the cylindrical prism used, as shown—and in such a way that a viewer or human observer Q at a middle vantage point as shown would perceive a different light intensity from the goniophotometric element PN than a vertically lower observer −Q or a higher observer +Q as shown. This effect can, for example, allow a user or viewer to see this effect upon rising from a chair, or can allow a user to make a small adjustment in viewing position to obtain a different light perceived light level or intensity from the goniophotometric element PN. This allows, based on small changes in viewing position, changing the intensity of ambient light produced, based on personal preference. Other optical shapes and forms can be used, including rectangular, triangular or irregularly-shaped prisms or shapes, and they can be placed upon or integral to distributive outer frame PF as desired. Rather than an isotropic output, the effect gained here can be bands of interesting light cast on surrounding walls, objects, and surfaces placed about the display D, making a sort of light show in a darkened room as the scene elements, color, and intensity change on the display. The number and type of goniophotometric elements that can be used is nearly unlimited, including pieces of plastic, glass, and the optical effects produced from scoring and mildly destructive fabrication techniques. The passive diffuser frame P can be made to be unique, and even interchangeable, for different theatrical effect.

Referring now to FIGS. 13-16, a number of alternate embodiments for light guidance and distribution are shown. FIG. 13 shows a passive diffuser frame similar to that of FIG. 9, but using partial internal reflection to provide lossless redirection of light inside the passive diffuser frame P. In this embodiment, light guide PG is formed so as to provide a critical surface upon which 100 percent internal reflection can occur, as will be described in greater detail below in the description for FIG. 18. This, as display output light K enters the light guide PG, some of its multidirectional light which happens to exceed a critical angle for internal reflection is redirected, being internally reflected to become internally reflected output light KX as shown, while other multidirectional light in display output light K remains under the critical angle, passing through light guide PG to become transmitted or undeflected output light KT, as shown. In this way, the light guide PG acts as a splitter or divider. As shown, this can provide a boost to selected areas on the distributive outer frame PF, with a particularly good production of light at the top of the distributive outer frame, showing as frame non-image light 3, and with the substantial remainder of the display output light K being undeflected to pass to the front of the passive frame, on the right side as shown in the figure. In this example, high light intensity would be found emanating from the distributive outer frame PF at the two points labeled as frame non-image light 3, as shown.

Nothing here implies that a simple block-style passive diffuser frame P cannot be used. FIG. 14 shows a view similar to that of FIG. 13, using a simple block diffuser as a light guide and a distributive outer frame, while FIG. 15 shows a similar embodiment using a simple transmissive block as a light guide and a distributive outer frame, without diffuser material. Similarly, the use of diffuser material can be used in a limited fashion, such as in FIG. 16 which shows the passive diffuser frame of FIG. 13, where the transparent light guide is formed to allow pumping of ambient light upward, without a frontal diffuser. As can be seen, internally reflected output light KX is sent upward, passing outward of light guide PG to become frame non-image light 3 sent into the ambient environment.

In the previous embodiments, the fiducial area FA of display D as described was sacrificed to provide light input to the passive diffuser frame P. This might be objectionable to some as an unwarranted reduction in available image size for original display image light 1. The scene detail lost might offend or annoy, or reduce interest in such an ambient light system. Another embodiment of this invention allows viewing of edge pixels (possibly displaced a bit spatially due to refractive effects) while allowing pumping of display output light K into the light guide PG of the passive diffuser frame P.

Referring now to FIGS. 17 and 18, close-up cross-sectional views of the upper portion of a display fitted with a splitter-prism equipped passive diffuser frame are shown according to this embodiment of the invention. In each figure, light guide PG is formed as shown to allow that a critical surface CS exists at or near the critical angle for total internal reflection. In FIG. 18, for example, the front face of distributive outer frame PF shown on the right of the figure is beveled to form a critical surface CS whose normal vector is about 45 degrees off from general output light outward direction D(K) as can be readily seen. Since the critical angle for internal reflection of most plastics is typically about 42 degrees, this present an opportunity to split the light entering the light guide PG, because with geometry chosen, approximately half the light entering will exceed the critical angle to become internally reflected output light KX as shown, becoming frame non-image light 3 as shown (although strictly speaking, an image can be preserved for projection upwards as shown, if diffusion is controlled)—and the other half of the light entering light guide PG will not be so redirected, but rather will pass forward to become transmitted output light KT and becoming frame image light 2 as shown. Thus, the viewer will perceive or discern the original character of the original display image in the fiducial area FA and yet, at the same time, light is available for pumping upward from distributive outer frame PF for ambient distribution. This diaphanous or transparent passive diffuser frame P thus allows viewing of the original display image throughout the entire display area under reduced intensity, which is not particularly noticed because of inherent compensating characteristics of the human visual system.

An additional feature is shown as well, namely the use of a frontal reflector or reflective surface T to reflect light internal inside the light guide PG to become ambient spill light (shown, Spill). This light can illuminate a back wall as shown in FIG. 7.

A demonstration of the appearance of this embodiment, by way of illustration, is shown in FIG. 19, which shows the frontal schematic view the upper portion of a display and passive frame of the embodiment of FIG. 18 and the continuity of an image through the passive diffuser frame and while allowing redirection of display output light to become ambient light. A portion of the sun shown, and an airplane shown on the display original image can be seen through the distributive outer frame PF across critical surface CS. Such images seen through the distributive outer frame PF are shown as frame image light 2; frame non-image light 3 is also shown emanating from distributive outer frame PF as before. The frontal reflector or reflective surface T shown can double in function as a chrome or other metal trim for aesthetic purposes, while it functions optically to help pump ambient light out the back of the passive diffuser frame P to provide back spill (not shown).

Generally, the teachings given here can be applied in a multitude of ways. The splitter prism geometry for distributive outer frame PF can comprise a single plane for entire frame border, as implied by the figure; or, alternatively, the frame can comprise four planes, one for each side of the display fiducial border, namely, the top, bottom, left & right sides. Alternatively, there can be regional prisms or small prisms, even pixel-size prisms to achieve the same effect on a small scale.

Generally, the form of the passive diffuser frame P can be as varied as the desired light transformative effects. The distribution of ambient light can be simple or complex. Simple diffuser blocks and the like can be used for distributing the light of general border pixels U in the fiducial area FA whose light will be then be distributed isometrically throughout the passive frame front face (and/or side faces) in the distributive outer frame PF to impart a general color output from the frame. On the other hand, regional or special effects can be obtained, by forming the light guide PG and distributive outer frame PF specifically to give preferential light pass-through or redirection in selected zones. There can be, for example, periodic pass-throughs, e.g., pegs, that provide ambient light in a particular direction or for a particular purpose, such as sending light into a desired area, or illuminating a specific feature, such as a red ball, blue line, etc. Particular side or border effects on the frame itself can be obtained.

One example of this can be seen by referring to FIG. 20, which shows the embodiment of FIG. 18, where the light guide PG comprises two light pipes P1 and P2 for further distribution of ambient light to specific places or for specific purposes, not shown. Ambient light M shown emanating from these light pipes can be optically pumped into other optical structures for use elsewhere, such as a floor mounted optical distributor (not shown) or a ceiling splash unit (not shown) for special effects. The light pipes could also be used to convey light for amplification for the purpose of ambient distribution.

As an alternative embodiment to the splitter prism embodiment illustrated in FIGS. 18-20, FIG. 21 shows the invention similar in function to that shown in FIG. 18, using a partially reflective surface T2 in lieu of internal reflection at the critical surface CS. As before, some light, namely internally reflected output light KX is reflected upwards for ambient distribution and emission as frame non-image light 3, while other light is transmitted to become transmitted output light KT. The distributive outer frame PF can be largely hollow as shown, with light paths as shown before in FIG. 18. Using a partially reflective surface T2 can be advantageous because there are no refractive displacement effects on the image to be discerned across critical surface CS as there are with the refractive internal reflection as shown in FIG. 18; however, using a partially reflective surface has the disadvantage of introducing some optical loss at the reflective surface, while the 100 percent internal reflection at critical surface CS of FIG. 18 is absolute. Again, a frontal reflector T is used to enhance back spill of ambient light as shown across the top of the display D. As an alternative to a partially reflecting surface T2, one can use selective reflectors on a small scale which individual reflect and redirect all display light, with light passing between such selective reflectors passing through to become frame image light.

One of the functions obtainable by the present invention is the production by the passive frame of chromaticities derived from, but not actually present, in the original display image light 1. This is done without any active intervention by the passive frame, and without reliance on hot or active sources of light, such as LEDs whose chromaticity, even when primary colors are combined, is hard to control as previously mentioned. The light redirected by the distributive outer frame PF can be non-imaging and mixed, allowing combinations of primary or other colors. This allows that two colors A and B from two distinct scenes areas on the display can form a chromaticity C not shown on the original image, but pleasing to the eye, as it is derived from original image content. This can be seen by referring to FIGS. 22-31.

Referring now to FIGS. 22 and 23, the embodiment of FIGS. 18 and 19 is given, using similar views already shown, and demonstrating color mixing of a color composite image on a video display to produce a ambient light chromaticity that is the result of combining the output of many display pixels in disparate display areas. FIG. 22 shows the top portion of a frontal surface view like that of FIG. 19. In this example, an airplane shown, discernible behind the passive diffuser frame P is red and produces bright red frame image light 2R, while the tops of some trees produce high intensity green frame image light 2G as shown. In FIG. 23, the corresponding display output light K is shown as two distinct sources KR and KG, red and green display output light, respectively. Some of this colored light KR and KG is substantially undeflected, emerging as frame image light 2, while some is internally reflected and redirected upward, combining at a top layer of distributive outer frame PF, mixing as shown (MIX) to produce a metameric yellow frame non-image light 3Y as shown. Thus, while the scene elements can be distinct and separate red and green, the ambient light produced by the passive frame can be yellow, providing an interesting theatrical effect. This is particularly enhanced with the use of a diffuser, as shown in FIG. 24, which resembles FIG. 13 in function. Such a functioning in illuminant mode requires that the source of red and green light in the example are bright, such as when this light is brought to bear on a small portion of the distributive outer frame PF using internal pegs or light pipes. The process in a basic block schematic diagram is shown in FIG. 25, where bright red and green light are brought together by a light guide PG to bear upon a distributive outer frame PF which performs an additive mix, resulting in yellow ambient light Y as shown.

In the likely event, however, that the delivery of red and green light is not very strong, the passive diffuser frame P will function in object mode, as shown in FIGS. 26 and 27. There, additive color mixing at the distributive outer frame PF produces brown light (Brown) as shown, which, as stated earlier, is not generally possible using bright active sources of light such as LEDs at close range.

In seeking to exploit characteristics of the human eye, color modulation can be achieved by the invention. The luminosity function of the visual system, which gives detection sensitivity for various visible wavelengths, changes as a function of light levels.

Scotopic or night vision relying on rods tends to be more sensitive to blues and greens. Photopic vision using cones is better suited to detect longer wavelength light such as reds and yellows. In a darkened home theatre environment, such changes in relative luminosity of different colors as a function of light level can be counteracted somewhat by modulating or changing color delivered to the video user. This can be done using a color subtraction step.

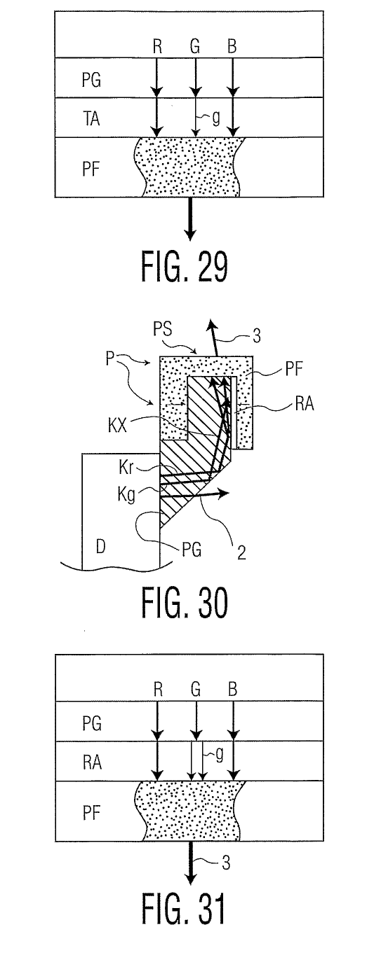

Accordingly, FIGS. 28-31 show similar paired drawings similar to those of FIGS. 24-27, for two more illustrative embodiments of the invention where the passive diffuser frame P comprises a transmissive absorber TA (FIG. 28), and a reflective absorber RA (FIG. 30) respectively, with corresponding light subtraction and addition processes schematically shown in FIGS. 29 and 31, respectively. Specifically, in FIG. 28, an interior surface of distributive outer frame PF is lined with a transmissive absorber TA, whose function is to absorb wavelengths of choice from being broadcast as frame non-image light 3. This transmissive absorber TA can be a metal foil such as gold; or an aniline dye; or any other absorber that is stable and capable of optical function within passive diffuser frame P. Metal foil such as thin gold foil allows passage of green and blue therethrough, absorbing longer wavelengths of light, which might be desired for high light level viewing. Another example is shown here schematically, where RGB light, after passing through the transmissive absorber TA, has some green light absorbed, producing low intensity green light g.

In lieu of a transmissive absorber TA, a reflective absorber can be used. In analogous fashion, FIGS. 30 and 31 show a reflective absorber RA lining one or more sides of light guide PG, so that light reflected therefrom as shown, is passed upward or elsewhere to the distributive outer frame PF for ambient distribution.

Further color transformations are possible using other embodiments of the invention. Referring now to FIGS. 32 and 33, another embodiment of the invention is shown whereby the passive diffuser frame performs a color transformation using a photoluminescent emitter. As shown in this example, light guide PG is lined with a photoluminescent emitter PE, which serves to absorb or undergo excitation from incoming display output light K, and undergo re-emission to desired wavelengths. This excitation and re-emission by a photoluminscent emitter, such as a fluorescent pigment, can allow rendering of new colors not originally present in the original video image, and perhaps also not in the range of colors or color gamut inherent to the operation of the display D. In the corresponding schematic process shown in FIG. 33, a new layer or functional step for photoluminscent emitter PE is shown, with an illustrative example being the production of orange light, such as hunter's orange, for which available fluorescent pigments are well known (see ref[2]). The example given involves a fluorescent color, as opposed to the general phenomenon of fluorescence and related phenomena, for which this figure is dedicated. Any photoluminescent compound, substance or material can be used for photoluminescent emitter PE, so long as it has activation or excitation potential for responding to display output light K.

Using a fluorescent orange or other fluorescent dye species can be particularly useful for low light conditions, where a boost in reds and oranges can counteract the decreased sensitivity of scotopic vision for long wavelengths.

Fluorescent dyes can include known dyes in dye classes such as perylenes, paphthalimides, coumarins, thioxanthenes, anthraquinones, thioindigoids, and proprietary dye classes such as those manufactured by the Day-Glo Color Corporation, Cleveland, Ohio, USA. Colors available include Apache Yellow, Tigris Yellow, Savannah Yellow, Pocono Yellow, Mohawk Yellow, Potomac Yellow, Marigold Orange, Ottawa Red, Volga Red, Salmon Pink, and Columbia Blue. These dye classes can be incorporated into resins, such as PS, PET, and ABS.

Fluorescent dyes and materials have enhance visual effects because they can be engineered to be considerably brighter than nonfluorescent materials of the same chromaticity. So-called durability problems of traditional organic pigments used to generate fluorescent colors have largely been solved in the last two decades, as technological advances have resulted in the development of durable fluorescent pigments that maintain their vivid coloration for 7-10 years under exposure to the sun. These pigments are therefore almost indestructible in a home theatre environment where UV ray entry is minimal.

Fluorescent photopigments work by absorbing short wavelength light, and re-emitting this light as a longer wavelength such as red or orange. Technologically advanced inorganic pigments are now readily available that undergo excitation using visible light, such as blues and violets, e.g., 400-440 nm light.

Highly fluorescent materials give rise to a unique color glow with seeming unnatural brilliance, known as fluorence, the psycho-physical perception of fluorescent color phenomena.

While this phenomenon remains largely unexplored, the relationship between the maximum theoretically achievable luminance (relative to white) as a function of chromaticity was quantitatively modeled by MacAdam (1935) and has since been known as the MacAdam limit in the color science literature. It has been suggested that fluorence can be specified by Y/YMacAdam (x,y), where Y is the relative reflectance or apparent reflectance of the fluorescent colored stimulus, and YMacAdam (x,y) is the MacAdam limit for the chromaticity coordinates (x,y) of the fluorescent colored stimulus.

FIG. 34 shows a comparison between the color transformation process of FIG. 33 according to the invention with that of conventional video color production by the display for the nearest available chromaticity. As shown, an original video image using primaries R, G and B produces a new orange color not inherently producible by the display, and compared to production of the same color of nearest chromaticity using light inherently produced by the display. The figure shows graphically that the light produced by a passive diffuser frame using a photoluminescent emitter according to the invention can exceed the MacAdam limit for that chromaticity.

Such a photoluminescent process can allow production of colors by distributive outer frame PF outside the gamut of colors available by inherent operation of display D. This is shown graphically in FIG. 35, where fluorescence results in production of an out-of-gamut color.

For illustrative purposes FIG. 36 shows a prior art plot of activation, reflection, fluorescence, and total output spectral distributions for a fluorescent material (hunter's orange) that might be used for the embodiment illustrated by FIGS. 32-35 (from ref[2], page 365). Photoluminescent emitter PE in this example is excited by shorter wavelengths shown as E. Ordinary reflectance processes shown by R are supplemented by a fluorescent emission spectral distribution shown by F, adding to give rise to a high-output total emission shown as HO, which can lie outside the inherent color gamut of display D.

FIG. 37 shows a cross-sectional oblique view of a portion of a simple splitter prism distributive outer frame PF which is integral with light guide PG. Light redirected so as not to become frame image light 2, e.g., the blue light shown, is send upward in the figure toward a photoluminescent emitter PE pad as shown at the top of the distributive outer frame PF. This converts the light output (e.g., blue light) in a manner similar that shown in FIG. 36 to out-of-gamut orange light, emerging as frame non-image light 3 as shown.

Such a process can easily produce ambient light outside the color gamut inherent to the display D. Referring now to FIG. 38, two possible ambient colors or chromaticity coordinates shown as M+can be found on a standard CIE x-y chromaticity diagram or color map. The map shows all known colors at maximum luminosity as a function of chromaticity coordinates x and y, with nanometer light wavelengths and CIE standard illuminant white points shown for reference. The chromaticity of ambient colors M+are readily shown to lie outside the gamut of colors obtainable by PAL/SECAM, NTSC, and Adobe RGB tristimulus color production standards as shown.

In analogy to the reflective absorber RA shown before, the photoluminescent emitter PE can incorporate reflective fluorescent materials, with the distributive outer frame PF formed and adapted to use reflection as a color modulation method in analogy to the method of FIG. 30, where a reflective photoluminescent emitter PE is substituted for reflective absorber RA is so that fluorescent species is a reflective coating.

It should also be noted that any number of known phosphorescent materials with long relaxation times (e.g., longer than 10ˆ-8 seconds, such as 1 second) can be substituted for or added to a fluorescent material in photoluminescent emitter PE. This can allow for special effects, such as a time delay or drag in the progress of luminescence of the passive diffuser frame P as scene elements play out on display D. This effect can make the ambient light output look scripted.

In another embodiment of the invention, FIG. 39 shows the passive diffuser frame as an oblique cross-section and comprising a goniochromatic element PN to produce different light colors, intensity, and character as a function of viewing angles Theta and Phi as shown. Phi is measured in a horizontal plane, and theta is measured in a vertical plane. As shown, a simple splitter prism serving as a combination light guide PG and distributive outer frame PF is shown receiving input light R, G, and B from a display (not shown). An optional photoluminescent emitter PE is shown as before—and notably, the light guide PG and/or distributive outer frame PF are in optical communication with a goniophotometric element PN, shown here as a front face FF. Goniophotometric element PN in the form of front face FF can use many known goniophotometric and goniochromatic elements, alone, or in combination, such as metallic and pearlescent transmissive colorants; iridescent materials using well-known diffractive or thin-film interference effects, e.g., using fish scale essence: thin flakes of guanine, or 2-aminohypoxanthine with preservative. Finely ground mica or other substances can be used, such as pearlescent materials made from oxide layers, bornite or peacock ore; metal flakes, glass flakes, plastic flakes, particulate matter, oil, ground glass, and ground plastic.

The front face FF can be treated, formed or scored to provide goniochromatic effects. For example, front face FF can comprises indentations, ribs, frosted areas, inclusions, including trapped air or particles, such as pieces of resin or glass. The goniochromatic effects can be effected through the use of either reflective or transmissive materials, as earlier described, in analogy to FIGS. 28 and 30, as will be appreciated by those skilled in the art. It should also be noted that the embodiment described in FIG. 12 can be mildly goniochromatic due to dispersion phenomena available by use of a prism.

The effect of such a passive diffuser frame P can be a theatrical element which changes light character very sensitively as a function of viewer position, such as viewing bluish sparkles, then red light when one is getting up from a chair.

To illustrate this, FIGS. 40 and 41 show Cartesian plots of dominant color wavelength of ambient light produced versus viewing angles Phi and Theta, respectively, for the goniochromatic embodiment illustrated in FIG. 39, using a iridescent front face FF. The wavelength or color of the light changes as a function phi and theta, respectively.

Scoring or other treatment of front face FF, including inclusion of small color elements therein, allows that light intensity changes goniophotometrically as shown in FIG. 42, which shows a Cartesian plot of relative light intensity of ambient light produced versus viewing angle Phi, for the otherwise goniochromatic embodiment illustrated in FIG. 39.

Generally, multiple optical elements, including small elements can be used for multiple feeds to the distributive outer frame.

The teachings given here can be applied to the design and construction of a video display or light transmissive device associated with a video display, incorporating elements and features taught here into same. The front face of a video display, for example, can be made with integral features as taught here. The passive diffuser frame does not have to be an added element.

Those with ordinary skill in the art will, based on these teachings, be able to modify the apparatus and methods taught and claimed here and thus, for example, morphologically and topologically re-arrange or re-shape components to suit specific applications.

The invention as disclosed using the above examples may be practiced using only some of the features mentioned above.

Also, nothing as taught and claimed here shall preclude addition of other structures or functional elements.

Obviously, many modifications and variations of the present invention are possible in light of the above teaching. It is therefore to be understood that, within the scope of the appended claims, the invention may be practiced otherwise than as specifically described or suggested here.

1. A passive diffuser frame system (P) for a video display unit (D), comprising:
a light guide (PG) sized, formed and positioned to allow optical communication with said video display unit so as to capture output light (K) therefrom;
a distributive outer frame (PF) in optical communication with said light guide, said distributive outer frame so sized, positioned and optically formed as to redirect said output light from itself to become cold emission ambient light (M).

2. The passive diffuser frame system of claim 1, wherein said distributive outer frame is formed optically such that said ambient light is non-imaging light (3).

3. The passive diffuser frame system of claim 1, wherein said distributive outer frame comprises an outer surface (PS) which transmits at least some of said ambient light.

4. The passive diffuser frame system of claim 3, wherein the distributive outer frame comprises a diffuser to diffuse the output light from said video display unit for diffuse light emission by said outer surface.

5. The passive diffuser frame system of claim 3, wherein said outer surface is formed, sized and positioned to spill said ambient light in at least one spill direction (Spill) that is contrary to that of said output light outwardly emitted (D(K)) by the video display.

6. The passive diffuser frame system of claim 1, wherein said distributive outer frame is so optically formed as to provide non-isotropic redirection of said output light to selected portions (PN) of same.

7. The passive diffuser frame system of claim 1, wherein said distributive outer frame comprises a light pipe (P1, P2) to redirect said output light to become ambient light by transmission therethrough.

8. The passive diffuser frame system of claim 1, wherein said light guide is so formed to split, by reflection, some of the output light from said video display unit to be redirected, and to allow other output light to pass substantially outwardly therefrom as imaging light (2).

9. The passive diffuser frame system of claim 8, wherein said light guide comprises a splitter prism, which in turn comprises a critical surface (CS) sized, positioned and formed to internally reflect and redirect substantially said some of the output light, and to be substantially transparent to said other output light, thereby allowing said imaging light to emerge from said critical surface, so as to allow at least discernment of an original image inherently emitted by the video display unit immediately adjacent the light guide with which it is in optical communication.

10. The passive diffuser frame system of claim 8, wherein said light guide comprises a partially reflective splitter which comprises a partially reflective surface (T2) sized, positioned and formed to internally reflect and redirect substantially said some of the output light, and to be substantially transparent to said other output light, thereby allowing said imaging light to emerge from said partially reflective surface, so as to allow at least discernment of an original image inherently emitted by the video display unit immediately adjacent the light guide with which it is in optical communication.

11. The passive diffuser frame system of claim 1, wherein said distributive outer frame is so sized, positioned and optically formed such that two chromatically distinct illuminant sources in said output light at different positions in the video display unit display area (DA) are mixed together to form a mixed image in viewer object mode of a different chromaticity (Brown) than original chromaticities (R, G) of either of said two chromatically distinct illuminant sources.

12. The passive diffuser frame system of claim 11, wherein said different chromaticity in said mixed image resembles an object mode color selected from the group consisting of:
brown, olive, maroon, grey, and beige flesh tone.

13. The passive diffuser frame system of claim 1, wherein said distributive outer frame is so sized, positioned and optically formed such that two chromatically distinct illuminant sources in said output light at different positions in the video display unit display area (DA) are mixed together to form a mixed image in viewer illuminant mode of a different chromaticity (Y) than original chromaticities (R, G) of either of said two chromatically distinct illuminant sources.

14. The passive diffuser frame system of claim 1, wherein said distributive outer frame comprises at least one absorber (TA, RA) to remove a portion of a spectral distribution of said output light so as to change the color of said ambient light.

15. The passive diffuser frame system of claim 14, wherein said absorber comprises a thin metal foil, so oriented and formed with a thickness sufficiently thin so as to allow transmission of said output light.

16. The passive diffuser frame system of claim 15, wherein said thin metal foil comprises gold.

17. The passive diffuser frame system of claim 14, wherein said absorber comprises an aniline dye.

18. The passive diffuser frame system of claim 14, wherein said absorber is a transmissive absorber (TA).

19. The passive diffuser frame system of claim 14, wherein said absorber is a reflective absorber (RA).

20. The passive diffuser frame system of claim 1, wherein said distributive outer frame comprises at least one photo-luminescent emitter (PE) to provide a spectral modification of said output light so as to color-modify said ambient light emitted from at least a portion of said passive diffuser frame system.

21. The passive diffuser frame system of claim 20, wherein said photo-luminescent emitter comprises a fluorescent material.

22. The passive diffuser frame system of claim 21, wherein said fluorescent material is chosen and said distributive outer frame is sized, oriented and formed so as to exceed a MacAdam limit when said ambient light is perceived by a viewer.

23. The passive diffuser frame system of claim 20, wherein said photo-luminescent emitter comprises phosphorescent material with a ruminant relaxation time constant of greater than 10ˆ-8 seconds.

24. The passive diffuser frame system of claim 20, wherein said photo-luminescent emitter is chosen such that said ambient light produced during light output from said display comprises at least one new color that is outside of a gamut of said output light colors inherently producible by said video display unit unaided by the passive diffuser frame.

25. The passive diffuser frame system of claim 1, wherein said distributive outer frame is so formed with a goniophotometric element (PN) so as to provide ambient light which is goniophotometric, that is, changing intensity as a function of an angle of observation (N, 2) of said passive diffuser frame system.

26. The passive diffuser frame system of claim 25, wherein said goniophotometric element is an optical lens.

27. The passive diffuser frame system of claim 26, wherein said optical lens is a prism.

28. The passive diffuser frame system of claim 25, wherein said goniophotometric element is a reflective surface.

29. The passive diffuser frame system of claim 25, wherein said goniophotometric element is transmissive.

30. The passive diffuser frame system of claim 25, wherein said goniophotometric element comprises a material selected from the group consisting of: metal flakes, glass flakes, plastic flakes, particulate matter, oil, fish scale essence, thin flakes of guanine, 2-aminohypoxanthine, ground mica, ground glass, ground plastic, pearlescent material, bornite, and peacock ore.

31. The passive diffuser frame system of claim 1, wherein said distributive outer frame is so formed with a goniochromatic element (PN) so as to provide ambient light which is goniochromatic, that is, changing color as a function of an angle of observation (N, 2) of said passive diffuser frame system.

32. The passive diffuser frame system of claim 31, wherein said goniochromatic element is an optical lens.

33. The passive diffuser frame system of claim 32, wherein said optical lens is a prism.

34. The passive diffuser frame system of claim 31, wherein said goniochromatic element is a reflective surface.

35. The passive diffuser frame system of claim 31, wherein said goniochromatic element is transmissive.

36. The passive diffuser frame system of claim 31, wherein said goniochromatic element comprises a material selected from the group consisting of: metal flakes, glass flakes, plastic flakes, particulate matter, oil, fish scale essence, thin flakes of guanine, 2-aminohypoxanthine, ground mica, ground glass, ground plastic, pearlescent material, bornite, and peacock ore.

37. A method for providing cold emission ambient light (M) from output light (K) emitted by a video display (D) and captured by a passive diffuser frame, comprising:
[1] Capturing said output light from said display using a light guide;
[2] Redirecting at least a portion of said output light to a surface (PS) in a distributive outer frame (PF) formed and positioned for perception by a viewer.

38. The method of claim 37, further comprising:
[3] Conditioning said output light using an appropriately formed distributive outer frame such that said output light becomes non-imaging light (3).

39. The method of claim 37, further comprising:
[4] Conditioning said output light using a diffuser such that said output light becomes non-imaging light (3).

40. The method of claim 37, further comprising:
[5] Redirecting said output light using a distributive outer frame so formed, sized and positioned to spill said ambient light in at least one spill direction.

41. The method of claim 37, further comprising:
[6] Redirecting said output light using a distributive outer frame so formed, sized and positioned as to provide non-isotropic redirection of said output light.

42. The method of claim 41, further comprising:
[7] Redirecting said output light using a light pipe (P1, P2) to redirect said output light to become ambient light by transmission therethrough.

43. The method of claim 37, further comprising:
[8] Redirecting said output light using a distributive outer frame so formed, sized and positioned to split, by reflection, some of the output light from said video display unit to be redirected, and to allow other output light to pass substantially outwardly therefrom as imaging light (2).

44. The method of claim 37, further comprising:
[9] Mixing together two chromatically distinct illuminant sources in said output light at different positions in the video display unit display area (DA) to form a mixed image in viewer object mode of a different chromaticity (Brown) than original chromaticities (R, G) of either of said two chromatically distinct illuminant sources.

45. The method of claim 44, further comprising:
[10] Producing said different chromaticity in an object mode color selected from the group consisting of: brown, olive, maroon, grey, and beige flesh tone.

46. The method of claim 37, further comprising:
[11] Mixing together two chromatically distinct illuminant sources in said output light at different positions in the video display unit display area (DA) to form a mixed image in viewer illuminant mode of a different chromaticity (Y) than original chromaticities (R, G) of either of said two chromatically distinct illuminant sources.

47. The method of claim 37, further comprising:
[12] using an absorber (TA, RA) in said distributive outer frame to remove a portion of a spectral distribution of said output light so as to change the color of said ambient light.

48. The method of claim 37, further comprising:
[13] Interacting said output light with a photo-luminescent emitter (PE) to provide a spectral modification of said output light so as to color-modify said ambient light emitted from at least a portion of said passive diffuser frame.

49. The method of claim 37, further comprising:
[14] Interacting said output light with a phosphorescent material to provide a spectral modification of said output light so as to color-modify said ambient light emitted from at least a portion of said passive diffuser frame, said phosphorescent material having long relaxation time of greater than 10ˆ-8 seconds.

50. The method of claim 48, further comprising:
[15] Producing at least one new color in said ambient light produced during light output from said display, said new color outside of a gamut of said output light colors inherently producible by said video display unit unaided by the passive diffuser frame.

51. The method of claim 37, further comprising:
[16] Providing ambient light which is goniophotometric, that is, changing intensity as a function of an angle of observation (N, 2) of said passive diffuser frame system, using a goniophotometric element (PN) in optical communication with said output light in said distributive outer frame.

52. The method of claim 51, further comprising:
[17] Reflecting said output light off of said goniophotometric element.

53. The method of claim 51, further comprising:
[18] Transmitting said output light through said goniophotometric element.

54. The method of claim 37, further comprising:
[19] Providing ambient light which is goniochromatic, that is, changing color as a function of an angle of observation (N, 2) of said passive diffuser frame system, using a goniochromatic element (PN) in optical communication with said output light in said distributive outer frame.

55. The method of claim 54, further comprising:
[20] Reflecting said output light off of said goniochromatic element.

56. The method of claim 54, further comprising:
[21] Transmitting said output light through said goniochromatic element.
